(19) United States
(12) Patent Application Publication
(10) Pub. No.: US 2012/0265619 A1
(43) Pub. Date: Oct. 18, 2012

(54) SYSTEM AND METHOD FOR DISPLAYING ADVERTISING

(76) Inventor: Michael L. Patnode, San Francisco, CA (US)

(21) Appl. No.: 13/447,757

(22) Filed: Apr. 16, 2012

Related U.S. Application Data
(60) Provisional application No. 61/475,665, filed on Apr. 14, 2011.

(51) Int. Cl. G06Q 30/02

(52) U.S. Cl. 705/14.71

(57) ABSTRACT

A system and method for displaying advertisements on an advertising display computer (ADC) at a plurality of geographic locations. In one example, the method comprises acts of receiving a selection associated with a geographic location of the plurality of geographic locations, receiving a selection associated with the ADC at the geographic location, displaying, via the computer interface, at least one advertising time slot available on the ADC at the geographic location, receiving at least one bid on the at least one advertising time slot available on the ADC, determining at least one winning bid from the at least one received bid, and transmitting an indication of the at least one winning bid to the ADC for display of an advertisement associated with the winning bit at the at lease one advertising time slot.

### RELATED APPLICATIONS

This application claims priority under 35 U.S.C. §119(e) to U.S. Provisional Application Ser. No. 61/475,665 entitled “SYSTEM AND METHOD FOR DISPLAYING ADVERTISING,” filed on Apr. 14, 2011, which is hereby incorporated herein by reference in its entirety.

### BACKGROUND

1. Applicable Field

The field of the present invention relates generally to displaying advertising and more particularly to systems and methods for advertising on display screens.

2. Related Art

Advertisers frequently employ computer displays for advertisements to attract consumer attention and influence consumer purchasing decisions. Typical computer displays show advertising content on indoor and outdoor display screens, which are placed in high traffic locations where people are likely to view advertisements that are displayed on such screens. Advertisers purchase advertising space from computer display providers that organize the advertising content, typically showing the advertisements sequentially.

### SUMMARY

It is appreciated that advertisers seeking to purchase advertising space lack control over when and how often the advertisements are shown. To better target specific audiences, advertisers may wish to selectively purchase placement of advertisements only during certain times of the day. Furthermore, advertisers can increase the likelihood that the advertisement is seen by the targeted consumer by increasing the frequently of the advertisement shown on the display during busiest time periods. Providers of computer displays may benefit from the advertisers' desire to advertise during high traffic time periods by charging the advertisers a premium. Although, the advertisers might be willing to pay the premium, they are more likely to pay a premium that reflects the demand for a particular advertising location at a particular time slot.

Aspects and embodiments of the present invention are directed to advertising systems and methods that present to one or more advertisers available locations and available time slots at those locations where advertisement may be displayed. The advertisers select the locations where they would like the advertisements to be shown and place bids on the available time slots at the selected locations. According to one embodiment, auctioning system and methods determine one or more winning bids among the received bids from the advertisers and display the advertisement on the advertising display computers at the selected locations.

According to one embodiment, a computer-implemented method for displaying advertisements on an advertising display computer (ADC) at a plurality of geographic locations is disclosed. The method comprises acts of receiving, via a computer interface, a selection associated with a geographic location of the plurality of geographic locations, receiving, via the computer interface, a selection associated with the ADC at the geographic location, and displaying, via the computer interface, at least one advertising time slot available on the ADC at the geographic location. In addition, the method further comprises the acts of receiving at least one bid on the at least one advertising time slot available on the ADC, determining at least one winning bid from the at least one received bid, and transmitting an indication of the at least one winning bid to the ADC for display of an advertisement associated with the winning bit at the at lease one advertising time slot.

In the method, the ADC may be configured to display the advertisement at a designated frequency. In addition, the method further comprises an act of displaying the at least one available time slot having at least one frequency associated with the advertisements displayed on the ADC.

In at least one embodiment, the method further comprises an act of receiving at least one bid on the at least one advertising time slot having the associated at least one frequency. In some embodiments, the method further comprises an act of determining the at least one winning bid from the at least one received bid at the at least one adverting time slot with the associated at least one frequency. In addition, the method may comprise an act of transmitting an indication of the winning bid to the ADC for display of the advertisements at the at least one adverting time slot at the at least one frequency.

In the method, the act of receiving at least one bid on the at least one advertising time slot available on the ADC comprises receiving at least one bid associated with a plurality of ADCs. Further in the method, the act of receiving at least one bid associated with a plurality of ADCs comprises receiving at least one bid associated with a set of geographic locations of the plurality of geographic locations. In addition, the at least one advertising time slot is associated with a period of time and the at least one bid is associated with a price. In one embodiment, the method further comprises an act of receiving advertisement information from the ADC, wherein advertisement information includes at least one of: timestamp information and frequency information.

According to another embodiment, a system for displaying advertisements on an advertising display computer (ADC) at a plurality of geographic locations is disclosed. The system comprises an auction interface configured to receive a selection associated with a geographic location, of the plurality of geographic locations, receive a selection associated the ADC located at the geographic location, and display at least one advertising time slot available on the ADC at the geographic location. The auction interface may be further configured to receive at least one bid on the at least one advertising time slot available on the ADC.

The system further comprises an auction engine configured to determine the at least one adverting time available on the ADC at the selected geographic location, and determine at least one winning bid from the at least one received bid. The system may further comprise a scheduling server configured to transmit at least one advertisement associated with the winning bid to be displayed on the ADC at the geographic location at the at least one time slot.

In the system, the at least one time slot may be associated with at least one designated frequency. In one embodiment, the auction interface is configured to receive a bid on the at least one time slot having the associated at least one frequency. In some embodiments, the scheduling server is configured to transmit the at least one advertisement to the ADC to be displayed at the at least one frequency.

The system may further comprise a media database for storing at least one advertisement. In one embodiment, the system may further comprise a reporting engine configured to receive advertisement information from the ADC, wherein advertisement information includes at least one of: timestamp information and frequency information. In the system, the auction interface may be further configured to receive a selection associated with a plurality of ADCs. In one embodiment, the auction interface may be further configured to receive a selection associated with a set of geographic locations of the plurality of geographic locations.

According to another embodiment, a non-transitory, non-volatile, computer readable medium having stored thereon sequences of instruction for displaying advertisements on an advertising display computer (ADC) at a plurality of geographic locations is disclosed. The sequences of instructions include instructions that will cause a processor to receive a selection associated with a geographic location of the plurality of geographic locations, receive a selection associated with the ADC at the geographic location, and determine at least one advertising time slot available on the ADC at the geographic location.

In addition, the sequences of instructions include instructions that will cause the processor to receive at least one bid on the at least one advertising time slot available on the ADC, determine at least one winning bid from the at least one received bid, and determine a schedule comprising an advertisement associated with the at least one winning bid at the at least one advertising time slot. The non-volatile, non-transitory, computer readable medium may further comprise instructions to receive a bid on the at least one time slot having an associated at least one frequency and determine the schedule comprising the advertisement associated with the winning bid to be displayed at the at least one frequency.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Further features and advantages as well as the structure and operation of various embodiments are described in detail below with reference to the accompanying drawings. In the drawings, like reference numerals indicate like or functionally similar elements. Additionally, the left-most one or two digits of a reference numeral identifies the drawing in which the reference numeral first appears.

FIG. 1 is a block diagram of one example of a system of displaying advertising, according to according to various embodiments of the present invention;

FIG. 2 is a block diagram of one example of a system of auctioning advertising time slots, according to embodiments of the present invention; and

FIG. 3 is an example of a screen of an auction interface and engine, according to embodiments of the present invention; and

FIG. 4 is a flow diagram illustrating one example of a method of auctioning advertising time slots, according to embodiments of the present invention.

### DESCRIPTION

As described above, advertisers may want to selectively purchase placement of advertisements only during certain times of the day to better target specific audiences of consumers. Accordingly, there is a need to create systems and methods of auctioning advertising time slots on advertising display computers at a number of locations. Such systems and methods provide to advertisers the ability to deliver their promotional message at the right place and at the right time at a price that matches their willingness to pay.

Aspects disclosed herein, which are in accordance with various embodiments, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to, performing one or more advertising auction functions. However, such a system may also perform other functions. Moreover, the systems described herein may be configured to include or exclude any of the functions discussed herein. Thus the embodiments of the present invention are not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

According to one embodiment, an advertiser who wants to promote his or her business creates an advertisement for that business to be displayed on a computer display at one or more locations. The advertiser may upload the advertisement to a central location that stores the advertisements for one or more advertiser associated with one or more advertising locations. Once the advertisement is approved, the advertiser, through a user interface, may select one or more locations where the advertiser would like to display the advertisement. In one embodiment, the advertiser is given the option to participate in an auction for the selected locations. The auction allows the advertiser can place bids on a listing of time slots at the selected locations. If the advertiser places a winning bid on the time slot, the advertisement may be transmitted to one or more advertising display computers, placed at the one or more commercial locations. The advertising display may then display the received advertisements according to the instructions received from the central server.

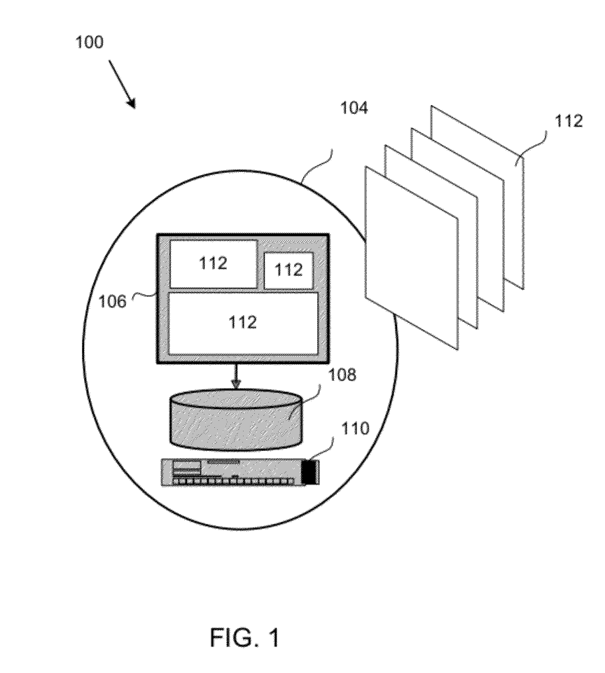

FIG. 1 shows one example of a system 100 of displaying advertisements at one or more locations, in which various aspects and functions according to embodiments of the present invention may be practiced. As illustrated in FIG. 1, the system 100 includes an advertising display computer (ADC) 104, which may be located at one or more commercial locations in one or more geographic areas. The commercial location may be any type of establishment where there is a frequent flow of customers. For example, the ADC 104 may be placed at a convenience store, supermarket, pharmacy, or gas station or other locations. As shown, the ADC 104 includes a display screen 106, local media storage 108 and a CPU 110. Although only one ADC 104 is shown, the system 100 may include any number of ADCs that may be placed at any number of locations.

The ADC 104 may be implemented as an integrated system, as described above, and may be hung on a wall or suspended from the ceiling at the commercial location. Alternatively, the ADC 104 may be implemented as a separate control unit and a separate display screen. For example, the control unit may be plugged into a display already present at the commercial location. In another embodiment, the ADC 104 may be a self-standing system, such as a kiosk.

The display screen 106 sequentially shows a number of advertisements 112 to customers who are located near the display. Any type of display may be utilized, including but not limited to a Cathode Ray Tube (CRT), a Liquid Crystal Display (LCD), a Plasma Display or a Light Emitting Diode (LED) Display. The advertisements may contain graphics, text, animation, video, audio or any combinations thereof and may be implemented using any multimedia platform. For example, platforms including but not limited to, the flash platform, including SWF, SVG and SMIL, as well as interactive visualizations, including HTML 5 and JAVA, video streaming, including Microsoft Silverlight, and video formats, including AVI, WMV, MPEG-4 may be used.

Each advertisement 112 displayed on the ADC 104 may be displayed for a predetermined length of time. For example, the advertisement may be displayed for 15 seconds, 30 seconds, 1 minute, or any other length of time. The advertisements 112 may be shown one at a time and occupy the entire display screen, the advertisements may be shown concurrently taking up different portions of the display screen 106. In one embodiment, the display time for each advertisement 112 may be predetermined by the advertiser. For example, the advertiser may offer 15 second or 30 second display periods, or any other display periods. Alternatively, the display time for each advertisement 112 may be determined by the system provider and stored on the central server.

The display screen 106 may include a touch screen system that allows customers to touch or select areas of the screen (referred to herein as hot-zones) by pressing on the screen. Once a hot-zone is selected by a customer, new content may appear on the display screen using the same or different multimedia platform. The interaction steps between the user and the display screen 106 may be processed by the CPU 110 and stored onto the local media storage 108. The touch screen system may provide for a more interactive experience for the user of the ADC.

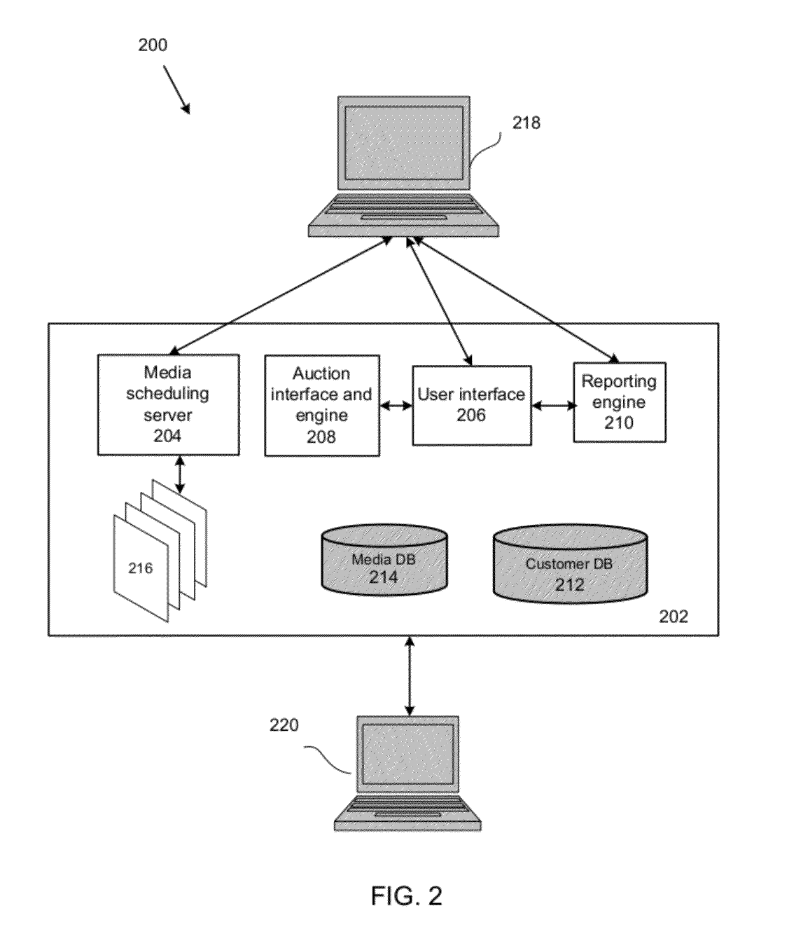

According to one example of the system 100, the advertisements 112 shown on the display screen 106 are transmitted from a central server 202 (shown in FIG. 2) and stored on the local media storage 108. In addition to the advertisements, control information for displaying the advertisements may also be transmitted from the central server 202 and stored on the local media storage 108. For example, the control information may include the period of time to display the advertisement content, the placement of the advertisement on the display screen, the size of the advertisement in proportion to the screen, and the sequence of advertisements and/or other content.

The local media storage 108 may comprise a computer readable and writeable, non-transitory, nonvolatile, storage medium in which instructions are stored that define one or more programs to be executed by the CPU 110. For example, the programs may include a multimedia player designed to play or display the advertisement in multiple multimedia file formats utilized by the system. The medium may, for example, be optical disk, magnetic disk or flash memory, among others. However, local media storage 108 is not limited to a particular memory system or storage system.

The ADC 104 may also include the CPU 110 which may comprise one or more microprocessors or other types of controllers, can perform a series of instructions that result in manipulated data. The CPU 110 may be a commercially available processor such as an Intel Xeon, Itanium, Core, Celeron, Pentium, AMD Opteron, Sun UltraSPARC, IBM Power5+, or IBM mainframe chip, but may be any type of processor, multiprocessor or controller. As shown, the CPU 110 may be connected to other system elements, including the local media storage 108 and the display screen 106.

The ADC 104 may record information about the advertisements previously shown on the display screen 106 and store that information on the local media storage 108. For example, the CPU 110 may determine a display timestamp or time code, which may include the starting time and duration for each advertisement shown on the display screen 106. The CPU 110 may also determine display frequency, or how many times a particular advertisement was shown on the display screen 106 during a predetermined period of time, such as over 1 hour, 8 hours or 12 hours. Display times and display timestamp information may be stored locally on each ADC 104 and transmitted to the central server in real-time, as the information is obtained, or on demand from the central server. Alternatively the information may be transmitted to central server on a regular basis, for example, at the end of the business day.

The ADC 104 may further include other computer components, such as a memory that may be used for storing programs and data during operation of the ADC 104, communication bus or other internal communication system that may enable communications to be exchanged between system components of the ADC 104, and a communication device that allows communication between the ADC 104 and the central server 202. In one embodiment, the ADC 104 includes input and output ports that allow a number of peripherals to be connected to the ADC 104. Examples include barcode scanners, mouse devices, trackballs, magnetic strip readers, microphones, touch screens, printing devices, speakers, etc.

The ADC 104 may include an operating system that manages at least a portion of the hardware elements included in ADC 104. A processor or controller, such as the CPU 110, may execute an operating system which may be, among others, a Windows-based operating system (for example, Windows XP, Windows Vista or Windows 7) available from the Microsoft Corporation, a MAC OS System operating system available from Apple Computer, one of many Linux-based operating system distributions or a UNIX operating systems available from various sources. Many other operating systems may be used, and embodiments are not limited to any particular operating system.

FIG. 2 shows one example of a system 200 of auctioning time slots on one or more ADCs 104, in which various aspects and functions according to aspects and embodiments of the present invention may be practiced. For example, as illustrated, the system includes a central server 202 which further includes a media scheduling server 204, a user interface 206, an auction engine and interface 208, a reporting engine 210, a customer database 212 and a media database 214.

In one embodiment, the media scheduling server 204 may determine the advertising content and transmit control information to each ADC 104 to control the that content displayed on the ADC. The advertiser creates the advertisement and transmits the advertisement to the central server 202 where the advertisement is stored in the media database 214. The media scheduling server 204 may determine control information which is sent to the ADC 104 to control how the advertisement is displayed on the ADC 104. The media scheduling server 204 may create a queue or line-up 216 of advertisements for each ADC 104 at each commercial location.

The line-up 216 may include purchased advertisements for that particular location. In addition, the line-up 216 may include site-specific advertisements, which are advertisements specific to the commercial location. Site-specific advertisements may further include advertisements for goods or services sold on-site at the commercial location. For example, in the embodiments where the commercial location includes a convenience store, the site-specific advertisement might show weekly specials on specific goods sold in the store. The site-specific advertisements may be shown in exchange for placement of the ADC 104 in the commercial location. The line-up 216 may also include additional content, including other information that may be of interest to the consumer, such as, weather, news, local events, quotes or trivia. Additional content may initially attract the consumer's attention to the ADC 104, or to continue to keep the consumer's attention after one or more advertisements are shown.

In one example, the media scheduling server 204 schedules the purchased advertisements and the site-specific advertisements uniformly throughout the line-up 216 for the duration of a business day at the commercial location. Depending on the number of purchased advertisements and site-specific advertisements, the line-up 216 may be supplemented with announcements containing additional information of interest to customers. Each advertisement or announcement may be repeated at regular intervals throughout the business day.

According to various embodiments, the auction interface and engine 208 provides for the advertiser to participate in an auction for advertisement time slots on the ADC 104 by placing bids on time slots available on the ADC in a particular commercial location. The auction engine and interface 208 determines a winning bid from the one or more bids placed by one or more advertisers. The bids are associated with on one or more time slots on the ADC 104 at a respective commercial location. By placing the winning bid the advertiser increases the advertisement frequency of the advertisement in the line-up 216 at the selected time slot and location. Without participating in the auction, the advertisement may be displayed on the ADC 104 as part of the regularly scheduled line-up 216 with a default frequency.

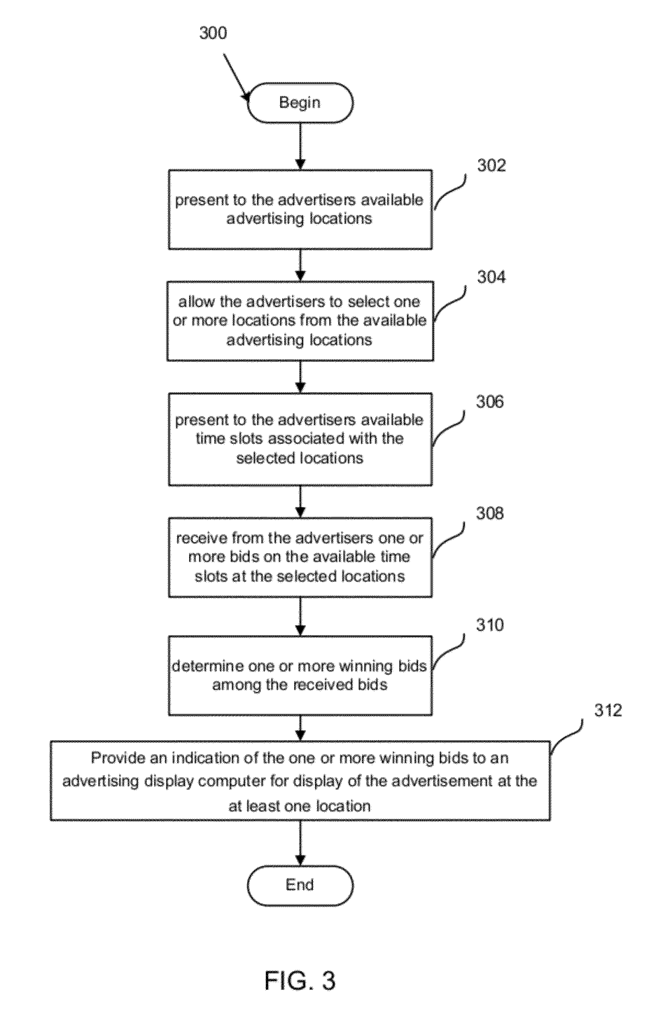

FIG. 3 shows a flow diagram illustrating one example of a method of auctioning advertising time slots, in which various aspects and functions according to aspects and embodiments may be practiced. The auction engine and interface 208 displays to one or more advertisers available commercial locations associated with geographic areas where one or more ADCs 104 are placed (step 302). The advertiser selects a commercial location (step 304) associated with a geographic area, the auction engine and interface 208 may display one or more time slots available on the ADC at each of the commercial locations (step 306). To secure the selected time slot, the auction engine and interface 208 provides an input for the advertisers to place bids on the selected time slot at the selected location (step 308). The input received from the advertiser may be transmitted to the auction interface and engine 208, which may determine one or more winning bids from the received bids (step 310). An indication of the winning bid for the associated timeslot may be displayed to the one or more advertisers and may be transmitted to the ADC 104 at the selected location (312) along with the associated advertisement. The ADC 104 receiving the indication of the winning bid may display the associated advertisement at the winning time slot and at the winning frequency.

In step 302, the auction interface and engine 208 displays available ADCs on an interactive map, which may be organized visually by geographical regions or areas. In one embodiment, the advertiser, through a series of successive selections in the auction interface and engine 208, may be able to view the ADCs located in a desired geographical region. Alternatively, the auction interface and engine 208 may display the available ADCs in the form of a list. The advertiser may be able to input a search via the auction interface and engine 208 for ADCs located in a particular geographic location by entering an address or zip code.

The advertiser, the auction interface and engine 208, may be able to select one or more commercial locations and the auction interface 208 may display additional information about the location, for example, a description and contact information for the location, as well as demographic information about customers frequenting that particular location. Providing additional information about each commercial location may help the advertiser determine whether the location is appropriate for the advertiser's target demographic. For example, if the target demographic is rush hour shoppers, the advertisers can select those locations near major commuting roadways. In one embodiment, the advertiser may be able to select more than one ADC in the geographical area to place bids on time slots at the multiple ADCs.

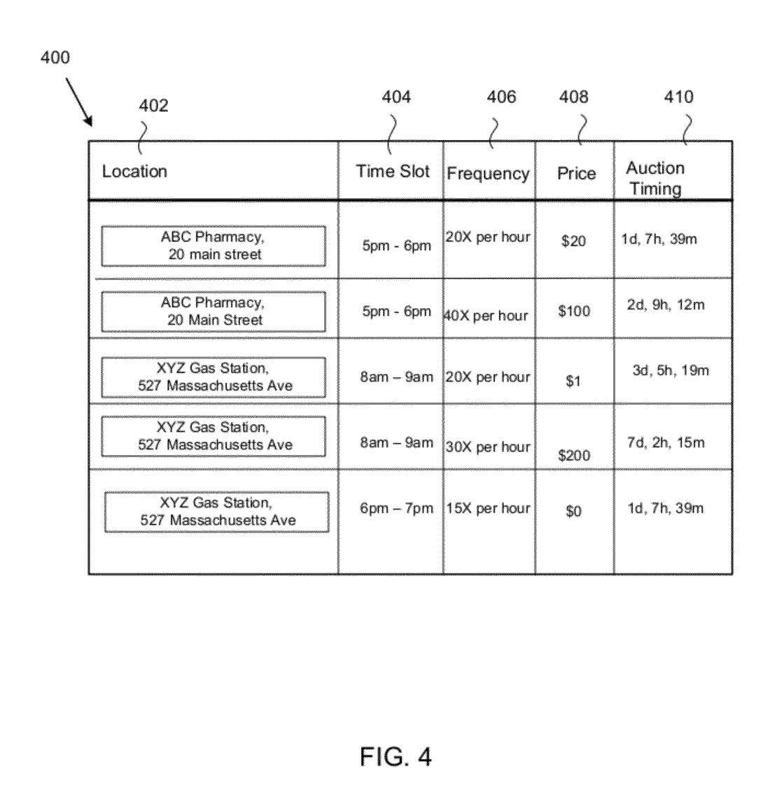

FIG. 4 shows one example of a screen 400 of the auctioning engine and interface 208. For example, after the advertiser selects one or more ADC locations 402, the auction interface and engine 208 may display time slots 404 available on the ADC at each of the selected commercial locations 402. Each time slot 404 may have a frequency 406 associated with the advertisement, which determines how often (or the number of times) the advertisement may be displayed on the ADC 104 during the selected time slot 404. In addition to the associated frequency, each time slot 404 may include a price 408 and auction timing 410 associated with the time slot 404. In one embodiment, to secure the selected time slot 404 and the associated frequency 406, the auction interface and engine 208 provides an input for the advertisers to place bids on the selected time slot at the selected location.

By placing a bid in the auction interface 208 on the time slot with the associated frequency, the advertiser can control the frequency of the advertisement shown on the selected ADC 104 during the selected time slot. The auction engine and interface 208 may list multiple auctions for each available time slot 404 with different associated frequencies 406. For example, the frequency 406 may be 30 times per hour, 20 times per hour or 10 times per hour. By increasing the frequency of the advertisement, the advertiser increases the likelihood that the advertisement is viewed by the target demographic. For example, if the target demographic is rush hour shoppers, the advertiser may select time slots during the morning or the evening commute hours.

According to one embodiment, the available time slots are offered in batches for different periods of time, for example, morning hours, lunch crowd, afternoon commute, or dinner hours. Alternatively, time slots may be available for each hour of a business day at each commercial location. In one embodiment, advertisers can select a reoccurring time slot for a longer period of time, for example, for the duration of a week, or a month.

In one embodiment, the auction engine and interface 208 receives successive bids placed by multiple advertisers on the time slots until the end of the auction time frame. In one example of an auction, the first advertiser may enter a first price into a purchase price field for the selected time slot and location. The next advertiser can then enter a second price into the purchase price field that may be a predetermined amount higher than the first price. The process continues until the end of the auction. The auction timing 410 until the end of the auction may be displayed as a countdown. The advertisement of the winning advertiser may be displayed at the selected time slot and location. As shown in FIG. 4, in one example, the price 408 reflects the most recent bid amount placed by an advertiser.

According to one embodiment, the winning bid may be the highest bid placed on the selected time slot by one of the advertisers. The advertisement associated with the winning bid may be displayed at the selected time slot and location. Alternatively, there may be one or more winning bids, for example any bids placed over a minimum threshold amount. The advertisements associated with the bids over the minimum threshold are displayed at the selected time slot and location.

In one embodiment, the auction engine and interface 208 starts the bidding price to start from zero. By placing a winning bid over a minimum threshold value, the auction engine and interface 208 may determine that the bid is winning In another embodiment, the auction interface 208 starts the bidding price at a predetermined minimum bid amount. Any first bid placed should be greater than a predetermined value over the minimum bid amount. In another embodiment, the auction interface 208 may include a “buy now” option, which may be a predetermined price for which the selected time slot can be purchased instantly. In the embodiment where the advertiser selected the “buy now” option, the advertisement may be displayed at the selected time slot and location without waiting for the end of the auction timing 410.

In another example, a reverse auction framework may be used in which advertisers place a bid having a price that reflects their willingness to pay for the particular time slot. The advertisers do not see other advertiser's bids. The auction engine and interface 208 may receive the bids on the timeslots from the advertisers and determine a winning price. In this example, any bids placed over the winning price are considered winning bids and the advertisements associated with the winning bids are displayed at the selected time slot and location. It is appreciated that other auctioning framework or methods currently known or later developed may be used may be used, as would be understood by those skilled in the art, given the benefit of this disclosure.

Referring again to FIG. 2, the central server 202 may include a user interface 206 that may allow the user to upload advertisements onto the central server 202 to be stored in the media database 214. The user interface 206 may be programmed in one or more computer languages (e.g., an HTML, Java, Macromedia Flash, or other type interface). According to one embodiment, one or more advertisers or commercial location owners can access the user interface 206 though a remote computer 218. In one example, the remote computer 218 renders a browser window by executing a browser program (e.g., the Internet Explorer browser program available from the Microsoft Corporation). The advertiser enters a URL address in a window of the browser interface, and is directed to a website associated with central server. This website may be rendered by, for example, a WWW server process associated with central server 202. The remote computer 218 may be a general purpose computer. Alternatively, other ways of accessing the user interface may be used (e.g., mobile phone, smart phone, tablet computer, PDA, or other method).

The user interface 206 may request that the advertiser create a user account by providing information about the advertiser, such as, contact information, billing information and account preferences. This information is stored in the customer database 212 and may be correlated with the advertisements stored in the media database 214. The advertiser may access multiple features of the user interface by entering a user identification and password associated with the advertiser's account.

According to one embodiment, the reporting engine 210, included in the central sever 202, may store, organize and display advertisement information from the ADC 104 at each of the commercial locations. As described above, the advertisement information received from the ADC 104 may include information stored locally on each ADC 104, for example, display frequency, timestamp, as well as other information. The information may be transmitted to the central server 202 in real-time as the information is recorded. In another example, the information may be transmitted to the central server 202 from the ADC on demand from the reporting engine 210. Alternatively, the advertisement information may be transmitted to the central server 202 on a regular basis, for example, every 2 hours, or at the end of a day. The reporting engine 210 may organize the information visually and display this information to advertisers through the user interface 206. The advertisement information produced by the reporting engine 210 may help the advertiser to correlate the display information to sales information.

In one embodiment, the reporting engine 210 may correlate the advertisement display information with sales transactions from point-of-sale terminals. By correlating the sales transactions to the reported data, the advertiser can determine whether the advertisements are having an impact on sales of specific products. In one example, the commercial locations use one or more point-of-sale terminals, such as cash registers, to process and record sales transactions between commercial locations and consumers. The sales information may be transmitted to the ADC 104 and stored in the local media storage 108. The sales transactions may be correlated to the purchased time slots of increased advertisement.

The ADC 104 may be communicate with the central server 202 through a number of connectivity methods, protocols or standards and may include any communication network through which computer systems may exchange data. For example, Ethernet, including DSL, Cable DSL, LAN or WAN, Wi-Fi, WiMAX, Bluetooth, Mobile Broadband, including EVDO, 1X, 3G, 4G, Satellite based internet, or protocols such as, TCP/IP, PHP, HTTP, FTP, SNMP, SMS, MMS, but may be any type of communication protocol or standards may be used.

In one embodiment, the central server 202 may provide a user interface for employees to access and manage the media database 214 and the customer database 212. The user interface may provide different levels of access to employees with different levels of authorization. For example, the central server 202 may provide sales employees access the customer database 212 to add new customers, while providing marketing employees access the media database to add and edit advertisements. The employees may access the respective databases through a remote computer 220. In one example, the remote computer 220 renders a browser window by executing a browser program (e.g., the Internet Explorer browser program available from the Microsoft Corporation). This browser window may render a website by, for example, a WWW server process associated with the central server 202. The remote computer 220 may be a general purpose computer. Alternatively, other ways of accessing the user interface may be used (e.g., mobile phone, smart phone, tablet computer, PDA, or other method).

The central server 202 may be a general-purpose computer system, or any other type of computer system capable of storing advertisements and user information, scheduling advertisements on one or more ADCs, providing a user interface and an auction interface, and performing other advertising and auction related functions. Further, it should be appreciated that various advertising functions may be performed by one or more server systems. Central server 202 generally includes a processor for executing server-based advertising and auctioning functions. Central server 202 may also include a memory for storing data associated with advertising programs, as well as, one or more network interfaces that permit central server to communicate with one or more ADCs. Further, central server 202 may include one or more storage entities, including disks or other media for storing data, such as, advertising media, location information and customer information. Central server may have any number or types of processors that execute an operating system and one or more application programs. In one embodiment, central server provides web server content to one or more advertisers for the purpose of accessing the user interface.

The central server 202 may be implemented using existing commercial products, such as, for example, Database Management Systems such as SQL Server available from Microsoft of Seattle Wash., Oracle Database from Oracle of Redwood Shores, Calif., and MySQL from Sun Microsystems of Santa Clara, Calif. or integration software such as WebSphere middleware from IBM of Armonk, N.Y.

Various aspects and functions described herein in accordance with the various embodiments of present invention may be implemented as hardware or software on one or more computer systems. There are many examples of computer systems currently in use that may be suitable for implementing various aspects and embodiments of the present invention. Some examples include, among others, network appliances, personal computers, workstations, mainframes, networked clients, servers, media servers, application servers, database servers and web servers. Other examples of computer systems may include mobile computing devices, such as cellular phones and personal digital assistants, network equipment, devices involved in commerce such as bar code scanners and other devices. Additionally, aspects in accordance with various embodiments of the present invention may be located on a single computer system or may be distributed among a plurality of computer systems connected to one or more communication networks.

Based on the foregoing disclosure, it should be apparent to one of ordinary skill in the art that the embodiments of the present invention are not limited to a particular computer system platform, processor, operating system, network, or communication protocol. Also, it should be apparent that the various embodiments of the present invention are not limited to a specific architecture or programming language.

Having now described some illustrative aspects and embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

What is claimed is:

1. A computer-implemented method for displaying advertisements on an advertising display computer (ADC) at a plurality of geographic locations, the method comprising acts of:
receiving, via a computer interface, a selection associated with a geographic location of the plurality of geographic locations;
receiving, via the computer interface, a selection associated with the ADC at the geographic location;
displaying, via the computer interface, at least one advertising time slot available on the ADC at the geographic location;
receiving at least one bid on the at least one advertising time slot available on the ADC;
determining at least one winning bid from the at least one received bid; and
transmitting an indication of the at least one winning bid to the ADC for display of an advertisement associated with the winning bit at the at lease one advertising time slot.

2. The method according to claim 1, wherein the ADC is configured to display the advertisement at a designated frequency.

3. The method according to claim 1, further comprising an act of displaying the at least one available time slot having at least one frequency associated with the advertisements displayed on the ADC.

4. The method according to claim 3, further comprising an act of receiving at least one bid on the at least one advertising time slot having the associated at least one frequency.

5. The method according to claim 4, further comprising an act of determining the at least one winning bid from the at least one received bid at the at least one adverting time slot with the associated at least one frequency.

6. The method according to claim 5, further comprising an act of transmitting an indication of the winning bid to the ADC for display of the advertisements at the at least one adverting time slot at the at least one frequency.

7. The method according to claim 1, wherein the act of receiving at least one bid on the at least one advertising time slot available on the ADC comprises receiving at least one bid associated with a plurality of ADCs.

8. The method according to claim 7, wherein the act of receiving at least one bid associated with a plurality of ADCs comprises receiving at least one bid associated with a set of geographic locations of the plurality of geographic locations.

9. The method according to claim 1, wherein the at least one advertising time slot is associated with a period of time and the at least one bid is associated with a price.

10. The method according to claim 1, further comprising an act of receiving advertisement information from the ADC, wherein advertisement information includes at least one of: timestamp information and frequency information.

11. A system for displaying advertisements on an advertising display computer (ADC) at a plurality of geographic locations, the system comprising:
an auction interface configured to:
receive a selection associated with a geographic location, of the plurality of geographic locations;
receive a selection associated the ADC located at the geographic location;
display at least one advertising time slot available on the ADC at the geographic location; and
receive at least one bid on the at least one advertising time slot available on the ADC;
an auction engine configured to:
determine the at least one adverting time available on the ADC at the selected geographic location; and
determine at least one winning bid from the at least one received bid; and
a scheduling server configured to transmit at least one advertisement associated with the winning bid to be displayed on the ADC at the geographic location at the at least one time slot.

12. The system of claim 11, wherein the at least one time slot is associated with at least one designated frequency.

13. The system of claim 12, wherein the auction interface is configured to receive a bid on the at least one time slot having the associated at least one frequency.

14. The system of claim 13, wherein the scheduling server is configured to transmit the at least one advertisement to the ADC to be displayed at the at least one frequency.

15. The system of claim 11, further comprising a media database for storing at least one advertisement.

16. The system of claim 12, further comprising a reporting engine configured to receive advertisement information from the ADC, wherein advertisement information includes at least one of: timestamp information and frequency information.

17. The system of claim 12, wherein the auction interface is further configured to receive a selection associated with a plurality of ADCs.

18. The system of claim 12, wherein the auction interface is further configured to receive a selection associated with a set of geographic locations of the plurality of geographic locations.

19. A non-transitory, non-volatile, computer readable medium having stored thereon sequences of instruction for displaying advertisements on an advertising display computer (ADC) at a plurality of geographic locations, including instructions that will cause a processor to:
receive a selection associated with a geographic location of the plurality of geographic locations;
receive a selection associated with the ADC at the geographic location;
determine at least one advertising time slot available on the ADC at the geographic location;
receive at least one bid on the at least one advertising time slot available on the ADC;
determine at least one winning bid from the at least one received bid; and
determine a schedule comprising an advertisement associated with the at least one winning bid at the at least one advertising time slot.

20. The non-transitory, non-volatile computer readable medium of claim 19, further comprising instructions to:
receive a bid on the at least one time slot having an associated at least one frequency; and
determine the schedule comprising the advertisement associated with the winning bid to be displayed at the at least one frequency.
